(19) United States
(12) Patent Application Publication
(10) Pub. No.: US 2004/0186855 A1
(43) Pub. Date: Sep. 23, 2004

(54) Client/server system and method of reproducing information therein

(76) Inventor: Hiroshi Gotoh, Kanagawa (JP)

Correspondence Address: DICKSTEIN SHAPIRO MORIN & OSHINSKY LLP, 2101 L STREET NW, WASHINGTON, DC, 20037-1526, US

(21) Appl. No.: 10/800,708

(22) Filed: Mar. 16, 2004

(30) Foreign Application Priority Data
Mar. 20, 2003 (JP) 2003-078124

(51) Int. Cl. G06F 17/00

(52) U.S. Cl. 707/104.1

(57) ABSTRACT

A method of reproducing information using an information recording medium in a client/server system is disclosed. The method includes the steps of: (a) a client obtaining the characteristic information of the information recording medium; (b) the client transmitting the characteristic information to a server; (c) the server obtaining the usage information of the information recording medium based on the characteristic information; (d) the server transmitting information based on the usage information to the client; and (e) the client reproducing the information recorded on the information recording medium in accordance with the information based on the usage information.

### BACKGROUND OF THE INVENTION

1. Field of the Invention

The present invention relates to a method of reproducing information, a client/server system in which the method is performed, a server and a client employed therein, and a computer-readable recording medium storing a program for causing a computer to execute the method.

2. Description of the Related Art

In recent years, fee-based services using the Internet, such as downloading and streaming, have become popular.

In such fee-based services, most means for user authentication employ a user ID and a password. Memory cards to which a user ID and a password are written are used as part of the user authentication means.

Conventionally, an ISP (Internet Service Provider) sign-up system using a hybrid disk has been proposed. According to this system, a server for membership registration is accessed using a membership application program pre-written to the read-only area (ROM area) of the hybrid disk, and information such as a user ID and a password obtained by the membership registration server is written to the writable area (RAM area) of the hybrid disk.

According to the conventional techniques, however, the services may not be used if the password is forgotten, or the services may be used illegally if other people have a glimpse of the password written down on a piece of paper, for instance. Further, in the case of using the memory card, a card reader is required. The card reader, however, is not widely used, thus preventing the memory card from being used freely at other locations (PCs).

Further, if the hybrid disk, to which a user ID and a password are written, is illegally duplicated, it is impossible to distinguish between the hybrid disk and its illegal duplicate, so that the services may be accessed illegally using the illegal duplicate of the hybrid disk.

### SUMMARY OF THE INVENTION

Accordingly, it is a general object of the present invention to provide a method of reproducing information in which the above-described disadvantages are eliminated.

A more specific object of the present invention is to provide a method of reproducing information that, by unifying management of data to be provided to users, can provide the users with convenience regarding the data and prevent illegal use of the data.

Another more specific object of the present invention is to provide a client/server system in which the above-described method is performed, a client and a server employed in the client/server system, and a computer-readable recording medium storing a program for causing a computer to execute the method.

One or more of the above objects of the present invention are achieved by a method of reproducing information using an information recording medium in a client/server system, the method including the steps of: (a) a client obtaining characteristic information of the information recording medium; (b) the client transmitting the characteristic information to a server; (c) the server obtaining usage information of the information recording medium based on the characteristic information; (d) the server transmitting information based on the usage information to the client; and (e) the client reproducing the information recorded on the information recording medium in accordance with the information based on the usage information.

One or more of the above objects of the present invention are also achieved by a method of reproducing information using an information recording medium in a client/server system, the method including the steps of: (a) a client obtaining characteristic information of the information recording medium; (b) the client transmitting the characteristic information to a first server; (c) the first server obtaining usage information of the information recording medium based on the characteristic information; (d) the first server transmitting first information based on the usage information to a second server; (e) the second server transmitting second information stored therein to the client in accordance with the first information based on the usage information; and (f) the client reproducing the information based on the second information received from the second server.

One or more of the above objects of the present invention are also achieved by a client/server system reproducing information using an information recording medium, including: a client and a server, wherein the client includes: a part configured to obtain characteristic information of the information recording medium; a part configured to transmit the characteristic information to the server; and a part configured to reproduce the information recorded on the information recording medium in accordance with information based on usage information of the information recording medium transmitted from the server; and the server includes: a part configured to obtain the usage information based on the characteristic information of the information recording medium; and a part configured to transmit the information based on the usage information to the client.

One or more of the above objects of the present invention are also achieved by a server providing information to a client using an information recording medium in response to a request of the client, the server including: a first part configured to receive characteristic information of the information recording medium from the client; a second part configured to obtain usage information of the information recording medium based on the characteristic information; and a third part configured to transmit to the client information as to whether reproduction of information from the information recording medium is authorized based on the usage information.

One or more of the above objects of the present invention are also achieved by a computer-readable recording medium storing a program for causing a computer to execute a method, the method including the steps of: (a) receiving, based on a request of a client using an information recording medium, characteristic information of the information recording medium from the client; (b) obtaining usage information of the information recording medium based on the characteristic information; and (c) transmitting to the client information as to whether reproduction of information from the information recording medium is authorized based on the usage information.

One or more of the above objects of the present invention are also achieved by a client requesting a server to provide information thereto, the client using an information recording medium, the client including: a first part configured to obtain characteristic information of the information recording medium; a second part configured to transmit the characteristic information to the server so that the server obtains usage information of the information recording medium; a third part configured to receive information based on the usage information from the server; and a fourth part configured to reproduce information recorded on the information recording medium in accordance with the information based on the usage information.

One or more of the above objects of the present invention are further achieved by a computer-readable recording medium storing a program for causing a computer to execute a method, the method including the steps of: (a) obtaining characteristic information of an information recording medium; (b) requesting a server to provide information and transmitting the characteristic information to the server so that the server obtains usage information of the information recording medium; (c) receiving information based on the usage information from the server; and (d) reproducing information recorded on the information recording medium in accordance with the information based on the usage information.

According to the method of reproducing information and the client/server system of the present invention, user convenience regarding data to be provided to a user can be provided and illegal use of the data can be prevented by unifying the management of the data. Further, according to the server and the client of the present invention, the functions for providing user convenience regarding data to be provided to a user and preventing illegal use of the data can be realized easily by unifying the management of the data in a normal computer. Furthermore, according to the computer-readable recording medium of the present invention, the functions according to the present invention can be realized by installing a program recorded on the recording medium.

### BRIEF DESCRIPTION OF THE DRAWINGS

Other objects, features and advantages of the present invention will become more apparent from the following detailed description when read in conjunction with the accompanying drawings, in which:

FIG. 1 is a diagram showing a hybrid disk management system according to an embodiment of the present invention;

FIG. 2 is a diagram for illustrating a record of a disk ID management database according to the embodiment of the present invention;

FIG. 3 is a diagram for illustrating the format of a hybrid disk according to the embodiment of the present invention;

FIGS. 4A and 4B are flowcharts showing the processing of a disk ID usage notification program in the hybrid disk management system of FIG. 1 according to the embodiment of the present invention;

FIGS. 5A and 5B are flowcharts showing the processing of a disk ID authentication program in the hybrid disk management system of FIG. 1 according to the embodiment of the present invention;

FIGS. 6A and 6B are flowcharts showing the processing of another disk ID authentication program in the hybrid disk management system of FIG. 1 according to the embodiment of the present invention;

FIG. 7 is a flowchart showing the processing of a disk ID usage stoppage program in the hybrid disk management system of FIG. 1 according to the embodiment of the present invention;

FIG. 8 is a flowchart showing an operation of a disk ID management server according to the embodiment of the present invention; and

FIG. 9 is a flowchart showing an operation of a client PC according to the embodiment of the present invention.

### DETAILED DESCRIPTION OF THE PREFERRED EMBODIMENTS

A description is given below, with reference to the accompanying drawings, of an embodiment of the present invention.

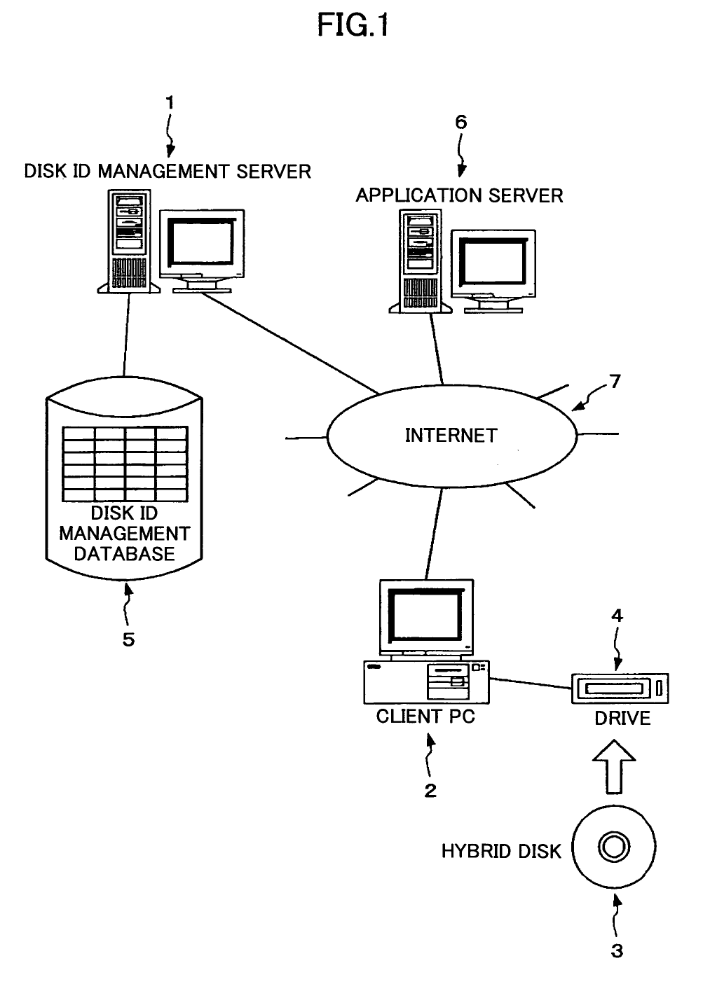

FIG. 1 is a diagram showing a hybrid disk management system according to the embodiment of the present invention. In this system, a hybrid CD-R (compact disk-recordable) may be employed as an information recording medium.

The hybrid disk management system includes a disk ID management server (a server or a first server) 1 and a client PC (personal computer) (a client) 2 that are connected to a network 7 such as the Internet.

A hybrid disk (an information recording medium) 3, which is a computer-readable recording medium, and a drive 4 for reading information from and writing information to the hybrid disk 3, such as a CD-R drive, are connected to the client PC 2.

The disk ID management server 1 includes a disk ID management database 5 for managing the disk ID (characteristic information) of the hybrid disk 3. An application server (a second server) 6 from which the client PC 2 receives a service is connected to the Internet 7.

Each of the disk ID management server 1, the client PC 2, and the application server 6 is realized by a microcomputer including a CPU, a ROM, and a RAM, and executes a disk ID usage notification program, a disk ID authentication program, and a disk ID usage stoppage program according to the present invention, thereby performing a method of reproducing information according to the present invention.

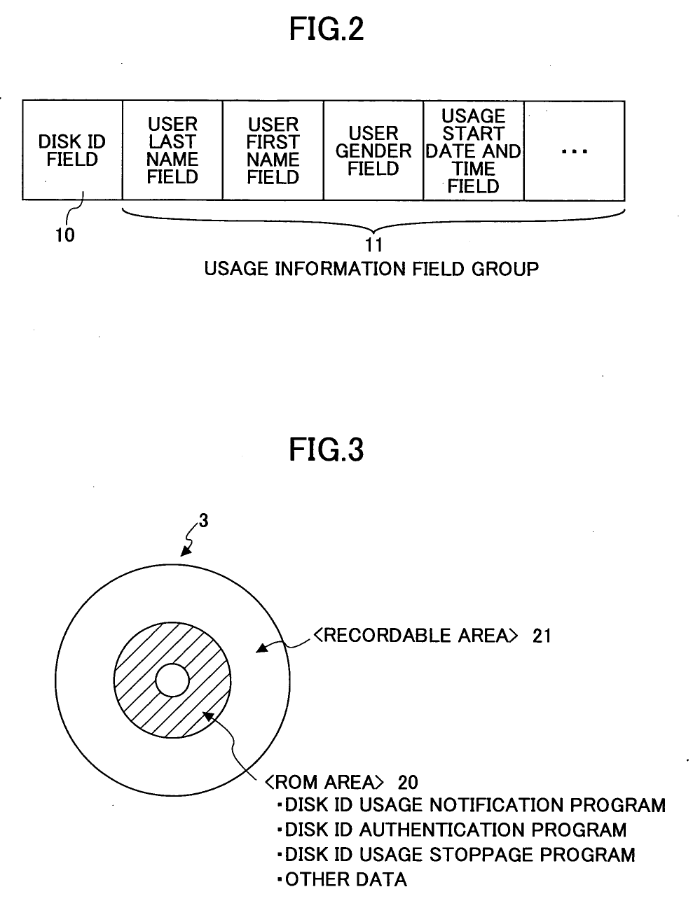

FIG. 2 is a diagram for illustrating a record of the disk ID management database 5. The record of the disk ID management database 5 is composed of a disk ID field 10 serving as a main key and a usage information field group 11. The usage information field group 11 is composed of: user information fields such as a user last name field, a user first name field, and a user gender field; and additional information such as a usage start date and time field.

Next, a description is given of the disk ID.

The disk ID (formally, Disc Identification) is data defined by the CD-R and CD-RW standards, the so-called Orange Book. The disk ID is written to the program memory area (PMA) of the hybrid disk 3.

The disk ID is composed of six figures set at random by the drive 4, and is employed as the identification information of the hybrid disk 3. Normally, the disk ID is written to the hybrid disk 3 only once. The disk ID written to the hybrid disk 3 can be read out by a READ PMA command by the drive 4.

The disk ID characteristic of the hybrid disk 3 employed in the hybrid disk management system of this embodiment is written thereto by a disk supplier in the process of manufacturing the hybrid disk 3.

As a result, the disk supplier possesses information on the disk IDs assigned to a plurality of hybrid disks 3. The disk ID management database 5 of the disk ID management server 1, in its initial state, stores records in each of which only the value of the disk ID assigned to the corresponding hybrid disk 3 is set in the disk ID field 10.

FIG. 3 is a diagram for illustrating the format of the hybrid disk 3.

The hybrid disk 3 is composed of a ROM area 20 only for data reading and a recordable area (RAM area) 21 on which data is arbitrarily recordable. At least the disk ID usage notification program, the disk ID authentication program, and the disk ID usage stoppage program are pre-written to the ROM area 20, for instance, in the process of manufacturing the hybrid disk 3. Further, a variety of data such as programs, images, moving images, and documents are recorded or to be recorded on the recordable area 21.

Next, a description is given of the processing of the disk ID usage notification program in the hybrid disk management system.

According to the disk ID usage notification program, the disk ID management server 1 has the disk ID management database 5 prestoring the disk ID information of the hybrid disk 3. When receiving an application for using the disk ID from the disk ID usage notification program pre-written to the ROM area 20 of the hybrid disk 3, the application being made by the client PC 2, the disk ID management server 1 stores the usage information corresponding to the disk ID in the disk ID management database 5.

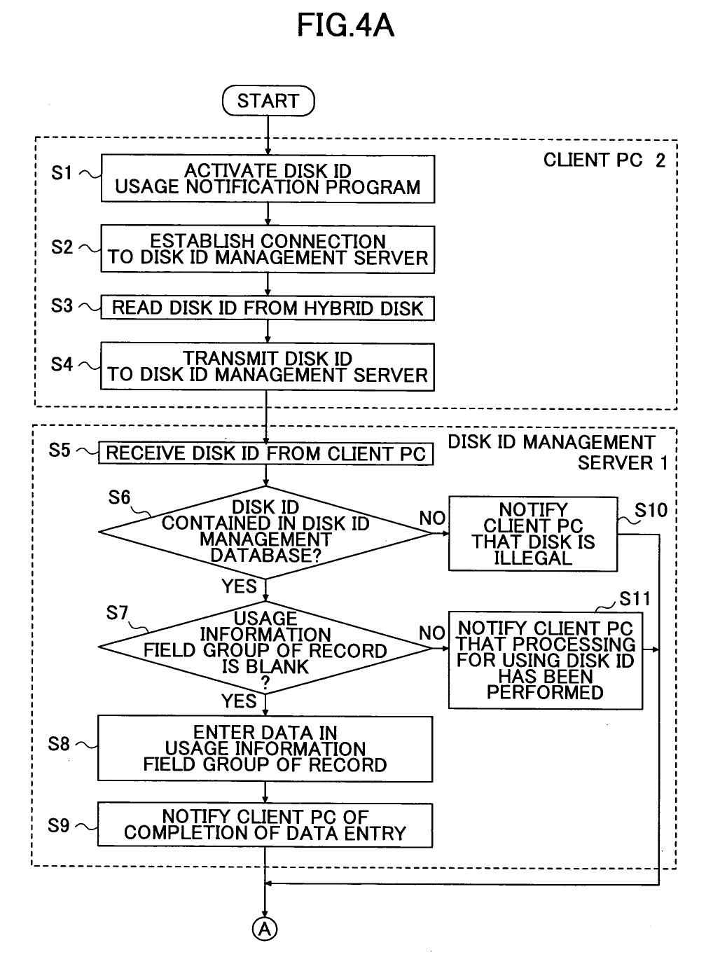

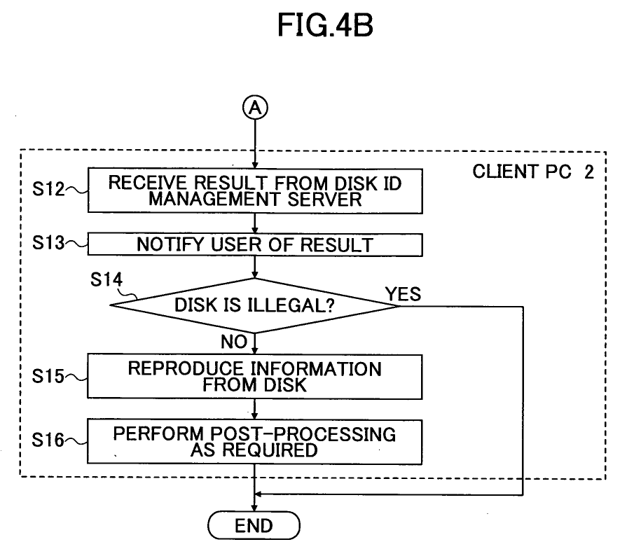

FIGS. 4A and 4B are flowcharts showing the processing of the disk ID usage notification program in the hybrid disk management system of FIG. 1.

When a user inserts the hybrid disk 3 (newly obtained) into the drive 4 connected to the client PC 2, in step S1 of FIG. 4A, the disk ID usage notification program is activated in the client PC 2. In step S2, the disk ID usage notification program establishes a connection to the disk ID management server 1 on the Internet 7 based on a preset connection method (communication protocol) and address information. After the connection to the disk ID management server 1 is established, in step S3, the disk ID usage notification program issues a READ PMA command to the drive 4 connected to the client PC 2, and reads the disk ID of the hybrid disk 3. Next, in step S4, the disk ID usage notification program transmits the read disk ID to the disk ID management server 1.

Next, in step S5, the disk ID management server 1 receives the disk ID transmitted from the client PC 2, and thereafter, searches the disk ID management database 5. Then, in step S6, the disk ID management server 1 determines whether the disk ID is contained in the disk ID management database 5. If the disk ID management database 5 contains no record in which the disk ID is set in the disk ID field (that is, “NO” in step S6), in step S10, the disk ID management server 1 notifies the client PC 2 that the hybrid disk 3 is an illegal disk, and proceeds to step S12.

If the disk ID management database 5 contains a record in which the disk ID is set in the disk ID field (that is, “YES” in step S6), in step S7, the disk ID management server 1 determines whether the usage information field group 11 of the record is blank. If the usage information field group 11 of the record is not blank (that is, “NO” in step S7), in step S11, the disk ID management server 1 notifies the client PC 2 that processing for using the disk ID has been performed, and proceeds to step S12.

If the usage information field group 11 of the record is blank (that is, “YES” in step S7), in step S8, the disk ID management server 1 enters data (sets information) in the usage information field group 11 of the record. At this point, the disk ID management server 1 may request user information from the disk ID usage notification program of the client PC 2 if necessary. In this case, the disk ID usage notification program may obtain necessary information from the user through a GUI, and transmit the obtained necessary information to the disk ID management server 1.

After entering the data in the usage information field group 11 of the record of the disk ID management database 5 in step S8, in step S9, the disk ID management server 1 transmits notification information indicating the completion of the data entry to the disk ID usage notification program of the client PC 2.

Next, in step S12 of FIG. 4B, the disk ID usage notification program of the client PC 2 receives the notification information from the disk ID management server 1. Then, in step S13, the disk ID usage notification program of the client PC 2 notifies the user of the result of the processing in the disk ID management server 1 (that the data entry is completed, that the hybrid disk 3 is an illegal disk, or that processing for using the disk ID has been performed) through a display by a GUI. Next, in step S14, the disk ID usage notification program determines whether the result received from the disk ID management server 1 indicates that the hybrid disk 3 is an illegal disk. If the result indicates that the hybrid disk 3 is an illegal disk (that is, “YES” in step S14), the disk ID usage notification program ends this processing. If the result does not indicate that the hybrid disk 3 is an illegal disk (that is, “NO” in step S14), in step S15, the client PC 2 reproduces information from the hybrid disk 3, activating an application and reading files. Then, in step S16, the disk ID usage notification program performs post-processing as required. For instance, information indicating the completion of usage entry may be written to the RAM area 21 of the hybrid disk 3 so as to prevent the disk ID usage notification program from being activated next time.

Thus, according to the hybrid disk management system of this embodiment, the disk ID management server 1 has the disk ID management database 5 prestoring the ID information of the hybrid disk 3. When the disk ID management server 1 receives an application for using the disk ID from the disk ID usage notification program pre-written to the ROM area 20 of the hybrid disk 3, the disk ID management server 1 stores the usage information corresponding to the disk ID in the disk ID management database 5. Accordingly, it is possible to unify management of the hybrid disk 3, so that it is possible to provide user convenience regarding the hybrid disk 3 and prevent the hybrid disk 3 from being illegally used.

Next, a description is given of the processing of the disk ID authentication program in the hybrid disk management system.

According to the disk ID authentication program, at a disk ID authentication request (a request for authenticating a disk ID) from the disk ID authentication program pre-written to the ROM area 20 of the hybrid disk 3, the disk ID management server 1 searches the disk ID management database 5 using information on the disk ID of the hybrid disk 3 transmitted from the client PC 2 as a key. If the disk ID and the usage information corresponding to the disk ID are contained in the disk ID management database 5, the disk ID management server 1 transmits information indicating that the disk ID has been authenticated to the client PC 2.

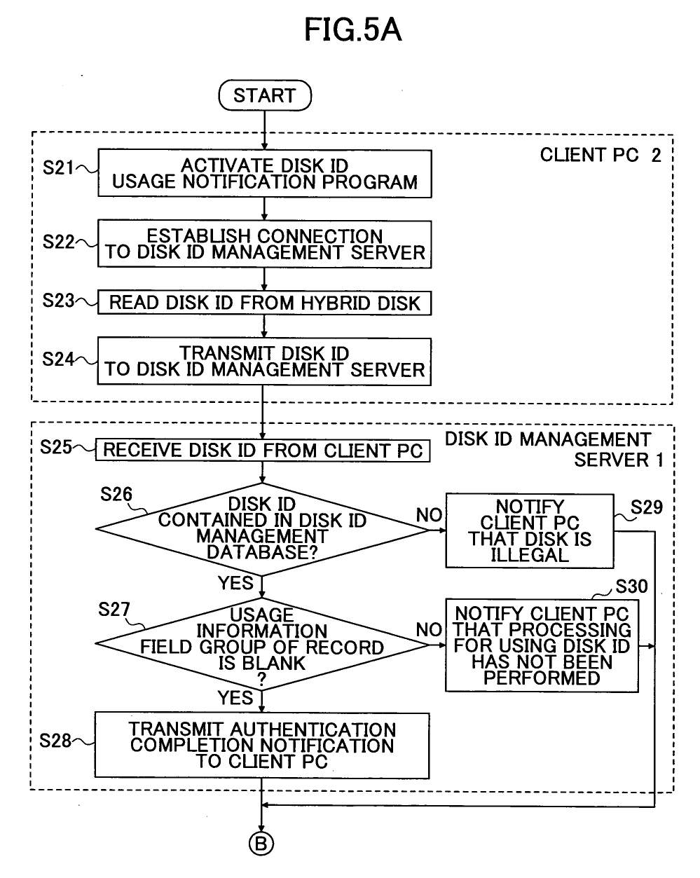

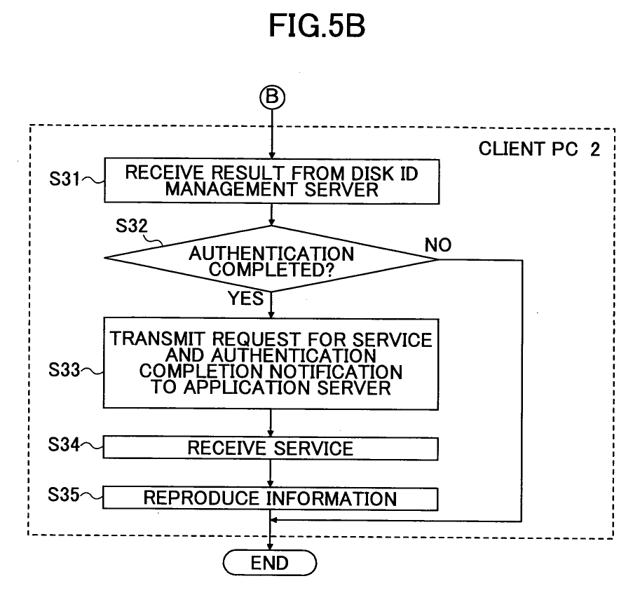

FIGS. 5A and 5B are flowcharts showing the processing of the disk ID authentication program in the hybrid disk management system of FIG. 1.

In the client PC 2, when a user uses a service provided by the application server 6 on the Internet, first, in step S21 of FIG. 5A, the disk ID authentication program written to the ROM area 20 of the hybrid disk 3 is activated. Next, in step S22, the activated disk ID authentication program establishes a connection to the disk ID management server 1 on the Internet 7 based on a preset connection method (communication protocol) and address information. After the connection to the disk ID management server 1 is established, in step S23, the disk ID authentication program issues a READ PMA command to the drive 4 connected to the client PC 2, and reads the disk ID of the hybrid disk 3. Next, in step S24, the disk ID authentication program transmits the read disk ID to the disk ID management server 1.

In step S25, the disk ID management server 1 receives the disk ID transmitted from the client PC 2, and thereafter, searches the disk ID management database 5. Then, in step S26, the disk ID management server 1 determines whether the disk ID is contained in the disk ID management database 5. If the disk ID management database 5 contains no record in which the disk ID is set in the disk ID field (that is, “NO” in step S26), in step S29, the disk ID management server 1 notifies the client PC 2 that the hybrid disk 3 is an illegal disk, and proceeds to step S31 of FIG. 5B.

If the disk ID management database 5 contains a record in which the disk ID is set in the disk ID field (that is, “YES” in step S26), in step S27, the disk ID management server 1 determines whether the usage information field group 11 of the record is blank. If the usage information field group 11 of the record is blank (that is, “YES” in step S27), in step S30, the disk ID management server 1 notifies the client PC 2 that processing for using the disk ID has not been performed, and proceeds to step S12.

If the usage information field group 11 of the record is not blank, and usage information is entered therein (that is, “NO” in step S27), in step S28, the disk ID management server 1 transmits “authentication completion notification” information indicating the completion of the authentication to the disk ID authentication program of the client PC 2.

In step S31 of FIG. 5B, the disk ID authentication program of the client PC 2 receives the “notification completion notification” information from the disk ID management server 1, and stores the “notification completion notification” information in the memory of the client PC 2.

Thereafter, in step S32, the disk ID authentication program determines whether the authentication is completed. If the authentication is not completed (that is, “NO” in step S32), the disk ID authentication program terminates this processing. If the authentication is completed (that is, “YES” in step S32), in step S33, when accessing the application server 6, whose service is to be used by the user, the disk ID authentication program transmits the “authentication completion notification” information together with a service usage request (a request for the service of the application server 6) to the application server 6.

Based on the “authentication completion notification” information received together with the service usage request, the application server 6 recognizes that the hybrid disk 3 possessed by the client PC 2 is a legal disk authenticated by the disk ID management server 1, and provides the service.

In step S34, the client PC 2 receives the service from the application server 6, and in step S35, uses the service. That is, in step S35, the client PC 2 reproduces information, activating an application and reading files, based on the service received from the application server 6.

Thus, according to the hybrid disk management system of this embodiment, at a disk ID authentication request from the disk ID authentication program pre-written to the ROM area 20 of the hybrid disk 3, the disk ID management server 1 searches the disk ID management database 5 using information on the disk ID of the hybrid disk 3 transmitted from the client PC 2 as a key. If the disk ID and the usage information corresponding to the disk ID are contained in the disk ID management database 5, the disk ID management server 1 transmits information indicating that the disk ID has been authenticated to the client PC 2. Accordingly, it can be determined whether the hybrid disk is legal.

Next, a description is given of the processing of another disk ID authentication program in the hybrid disk management system.

According to this disk ID authentication program, at a disk ID inquiry request (a request to make an inquiry about a disk ID) from the application server 6 connected by the Internet (network) 7 to the disk ID management server 1, the disk ID management server 1 searches the disk ID management database 5 using information on the disk ID of the hybrid disk 3 transmitted from the application server 6 as a key. If the disk ID and the usage information corresponding to the disk ID are contained in the disk ID management database 5, the disk ID management server 1 transmits information indicating that the inquiry about the disk ID has succeeded to the application server 6.

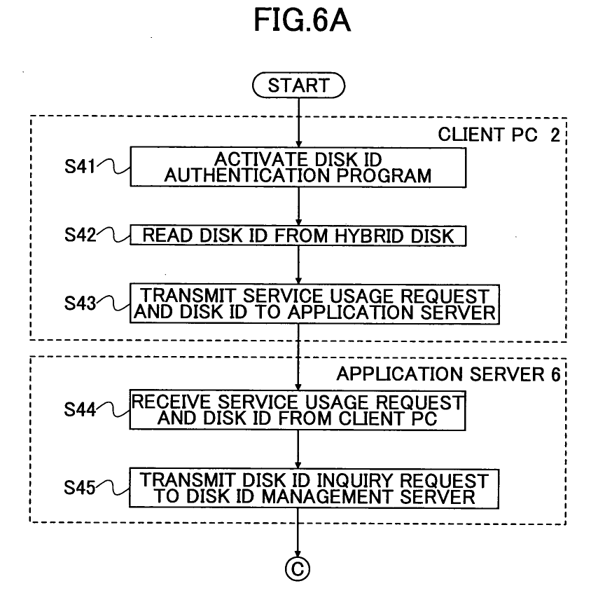

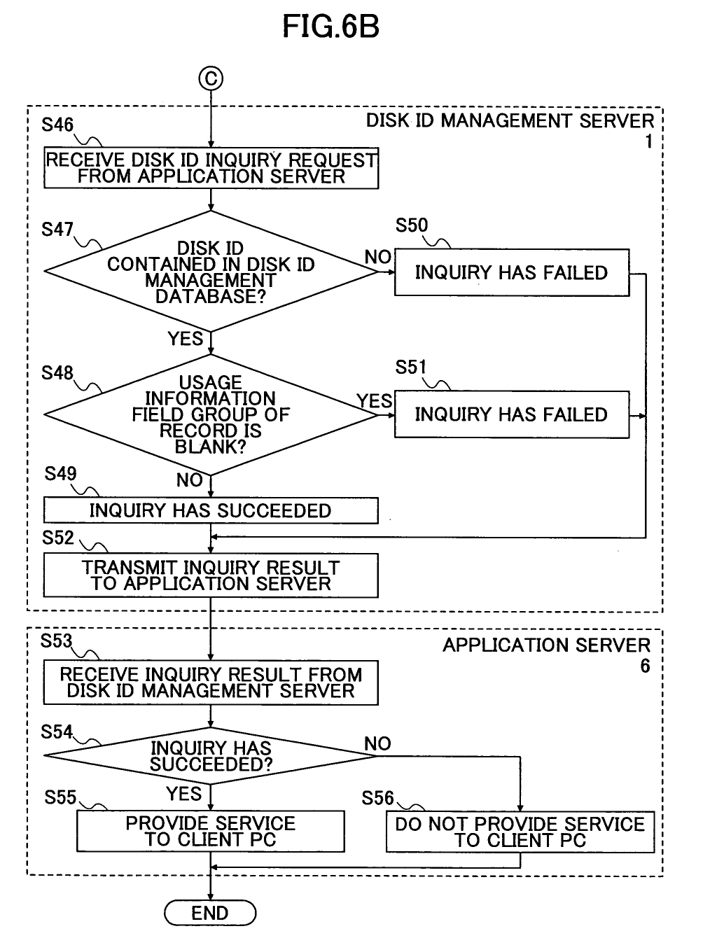

FIGS. 6A and 6B are flowcharts showing the processing of the other disk ID authentication program in the hybrid disk management system of FIG. 1.

In the client PC 2, when a user uses the service provided by the application server 6 on the Internet 7, first, in step S41 of FIG. 6A, the disk ID authentication program written to the ROM area 20 of the hybrid disk 3 is activated. Next, in step S42, the disk ID authentication program issues a READ PMA command to the drive 4 connected to the client PC 2, and reads the disk ID of the hybrid disk 3. Next, in step S43, the disk ID authentication program transmits the read disk ID together with a service usage request to the application server 6.

In step S44, the application server 6 receives the service usage request and the disk ID from the client PC 2. Then, in step S45, the application server 6 establishes a connection to the disk ID management server 1 on the Internet 7 based on a preset connection method (communication protocol) and address information, and transmits a request to make an inquiry about the disk ID (a disk ID inquiry request) to the disk ID management server 1.

In step S46 of FIG. 6B, the disk ID management server 1 receives the disk ID inquiry request from the application server 6, and thereafter, searches the disk ID management database 5. Then, in step S47, the disk ID management server 1 determines whether the disk ID is contained in the disk ID management database 5. If the disk ID management database 5 contains no record in which the disk ID is set in the disk ID field (that is, “NO” in step S47), in step S50, the disk ID management server 1 determines that the inquiry has failed. Then, in step S52, the disk ID management server 1 transmits an inquiry result indicating the failure of the inquiry to the application server 6, and proceeds to step S53.

If the disk ID management database 5 contains a record in which the disk ID is set in the disk ID field (that is, “YES” in step S47), in step S48, the disk ID management server 1 determines whether the usage information field group 11 of the record is blank. If the usage information field group 11 of the record is blank (that is, “YES” in step S48), in step S51, the disk ID management server 1 determines that the inquiry has failed. Then, in step S52, the disk ID management server 1 transmits an inquiry result indicating the failure of the inquiry to the application server 6, and proceeds to step S53.

On the other hand, if the usage information field group 11 of the record is not blank, and usage information is entered therein (that is, “NO” in step S48), in step S49, the disk ID management server 1 determines that the inquiry has succeeded. Then, in step S52, the disk ID management server 1 transmits an inquiry result indicating the success of the inquiry to the application server 6, and proceeds to step S53.

In step S53, the application server 6 receives the inquiry result from the disk ID management server 1. Then, in step S54, the application server 6 determines whether the received inquiry result indicates the success of the inquiry. If the inquiry result indicates the success of the inquiry (that is, “YES” in step. S54), in step S55, the application server 6 provides the requested service to the client PC 2. If the inquiry result indicates the failure of the inquiry (that is, “NO” in step S54), in step S56, the application server 6 does not provide the requested service to the client PC 2, and terminates this processing.

Thus, the application server 6 provides the requested service to the client PC 2 only when it is determined that the disk ID is legal.

This authentication method may be used as authentication for using an application program written to the ROM area 20 or the RAM area 21 of the hybrid disk 3, such as software for document writing and editing, software for audio, image, and moving image reproduction and editing, or game software.

Thus, according to the hybrid disk management system of this embodiment, at a disk ID inquiry request from the application server 6 connected by the Internet (network) 7 to the disk ID management server 1, the disk ID management server 1 searches the disk ID management database 5 using information on the disk ID transmitted from the application server 6 as a key. If the disk ID and the usage information corresponding to the disk ID are contained in the disk ID management database 5, the disk ID management server 1 transmits information indicating that the inquiry about the disk ID has succeeded to the application server 6. Accordingly, the application server 6 on the Internet (network) 7 can determine the legality of the disk ID received from the client PC 2.

Next, a description is given of the processing of the disk ID usage stoppage program in the hybrid disk management system.

According to the disk ID usage stoppage program, based on a disk ID usage stoppage notification from the disk ID usage stoppage program pre-written to the ROM area 20 of the hybrid disk 3, the disk ID management server 1 searches the disk ID management database 5 using information on the disk ID of the hybrid disk 3 transmitted from the client PC 2 as a key. If the disk ID is contained in the disk ID management database 5, the disk ID management server 1 deletes the usage information corresponding to the disk ID from the disk ID management database 5.

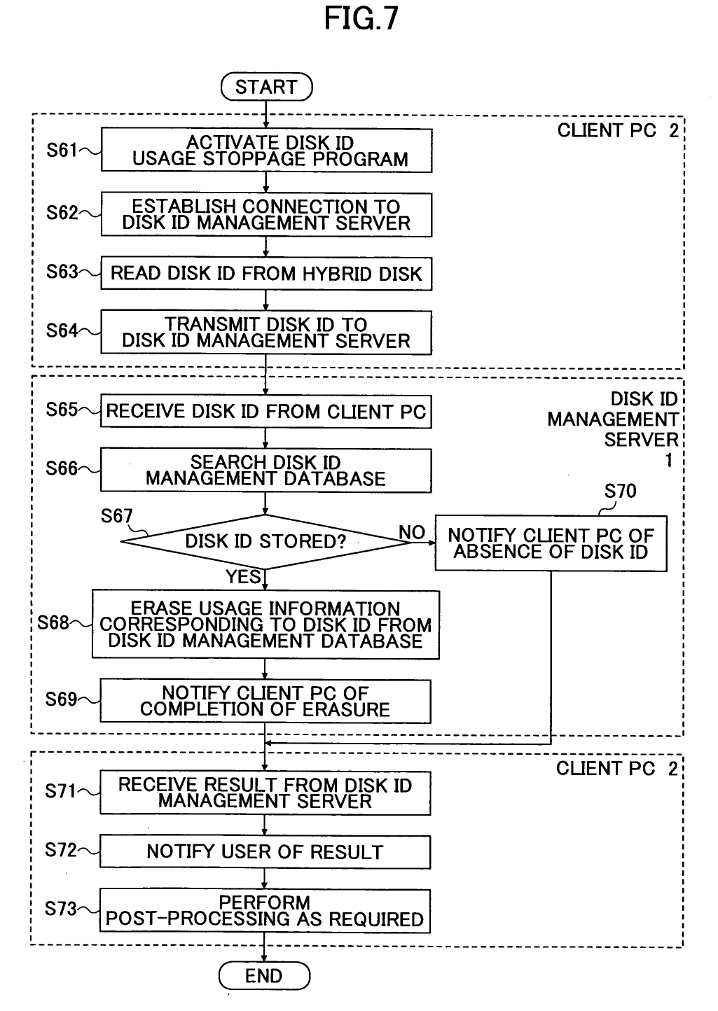

FIG. 7 is a flowchart showing the processing of the disk ID usage stoppage program in the hybrid disk management system of FIG. 1.

In the client PC 2, in step S61 of FIG. 7, the disk ID usage stoppage program pre-written to the ROM area 20 of the hybrid disk 3 is activated by the user. Then, in step S62, the activated disk ID usage stoppage program establishes a connection to the disk ID management server 1 on the Internet 7 based on a preset connection method (communication protocol) and address information. After the connection to the disk ID management server 1 is established, in step S63, the disk ID usage stoppage program issues a READ PMA command to the drive 4 connected to the client PC 2, and reads the disk ID of the hybrid disk 3. Next, in step S64, the disk ID usage stoppage program transmits the read disk ID to the disk ID management server 1.

In step S65, the disk ID management server 1 receives the disk ID transmitted from the client PC 2. Thereafter, in step S66, the disk ID management server 1 searches the disk ID management database 5. Then, in step S67, the disk ID management server 1 determines whether the disk ID management database 5 contains a record in which the disk ID is set in the disk ID field. If the disk ID management database 5 contains a record in which the disk ID is set in the disk ID field (that is, “YES” in step S67), in step S68, the disk ID management database 5 deletes the usage information entered in the usage information field group 11 of the record.

After deleting the usage information of the record from the disk ID management database 5, in step S69, the disk ID management server 1 transmits notification information indicating the completion of the deletion (erasure) of the usage information (the completion of processing for stopping the usage of the disk ID) to the disk ID usage stoppage program of the client PC 2.

On the other hand, if the disk ID management database 5 does not contain a record in which the disk ID is set in the disk ID field (that is, “NO” in step S67), in step S70, the disk ID management server 1 transmits notification information indicating that the disk ID is not stored in the disk ID management database 5 to the disk ID usage stoppage program of the client PC 2.

Then, in step S71, the disk ID usage stoppage program of the client PC 2 receives the notification information from the disk ID management server 1. Next, in step S72, the disk ID usage stoppage program notifies the user of the received information (the completion of the erasure or the absence of the disk ID) through a display by a GUI. Then, in step S73, the disk ID usage stoppage program performs post-processing as required. For instance, the information indicating the completion of usage entry written to the RAM area 21 of the hybrid disk 3 (step S16 of FIG. 4B) may be deleted.

Thus, according to the hybrid disk management system of this embodiment, based on a disk ID usage stoppage notification from the disk ID usage stoppage program pre-written to the ROM area 20 of the hybrid disk 3, the disk ID management server 1 searches the disk ID management database 5 using information on the disk ID of the hybrid disk 3 transmitted from the client PC 2 as a key. If the disk ID is contained in the disk ID management database 5, the disk ID management server 1 deletes the usage information corresponding to the disk ID from the disk ID management database 5. Accordingly, the hybrid disk 3 can be removed as an object of management by the disk ID management server 1.

Next, a description is given of another operation of the disk ID management server 1 of FIG. 1.

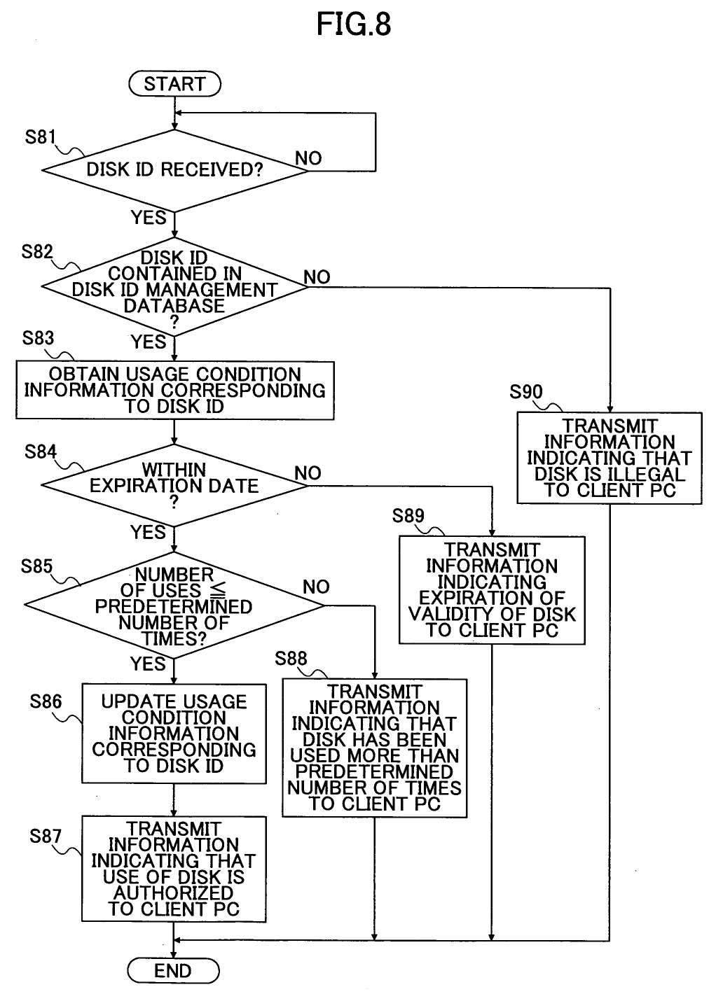

FIG. 8 is a flowchart showing the other operation of the disk ID management server 1.

According to this operation, in step S81 of FIG. 8, the disk ID management server 1 determines whether the disk ID management server 1 has received the disk ID of the hybrid server 3. If the disk ID management server 1 has received a disk ID (that is, “YES” in step S81), in step S82, the disk ID management server 1 determines whether the disk ID is contained in the disk ID management database 5. If the disk ID is not contained in the disk ID management database 5 (that is, “NO” in step S82), in step S90, the disk ID management server 1 transmits information indicating that the hybrid disk 3 is illegal to the client PC 2, and ends the operation. If the disk ID is contained in the disk ID management database 5 (that is, “YES” in step S82), in step S83, the disk ID management server 1 obtains the information on usage conditions (usage condition information) corresponding to the disk ID. Then, in step S84, the disk ID management server 1 determines whether the hybrid disk 3 is within a preset expiration date. If the hybrid disk 3 is not within the preset expiration date (that is, “NO” in step S84), in step S89, the disk ID management server transmits information indicating the expiration of the validity of the hybrid disk 3 to the client PC 2, and ends this operation.

If the hybrid disk 3 is within the preset expiration date (that is, “YES” in step S84), in step S85, the disk ID management server 1 determines whether the number of times the hybrid disk 3 has been used is less than or equal to a predetermined number of times. If the number of times the hybrid disk 3 has been used is more than the predetermined number of times (that is, “NO” in step S85), in step S88, the disk ID management server 1 transmits information indicating that the hybrid disk 3 has been used more than the predetermined number of times to the client PC 2, and ends this operation. If the number of times the hybrid disk 3 has been used is less than or equal to a predetermined number of times (that is, “YES” in step S85), in step S86, the disk ID management server 1 updates the usage condition information corresponding to the disk ID, that is, increments the number of times the hybrid disk 3 is used by one. Then, in step S87, the disk ID management server 1 transmits information indicating that the use of the hybrid disk 3 is authorized to the client PC 2, and ends this operation.

Next, a description is given of another operation of the client PC 2 of FIG. 1.

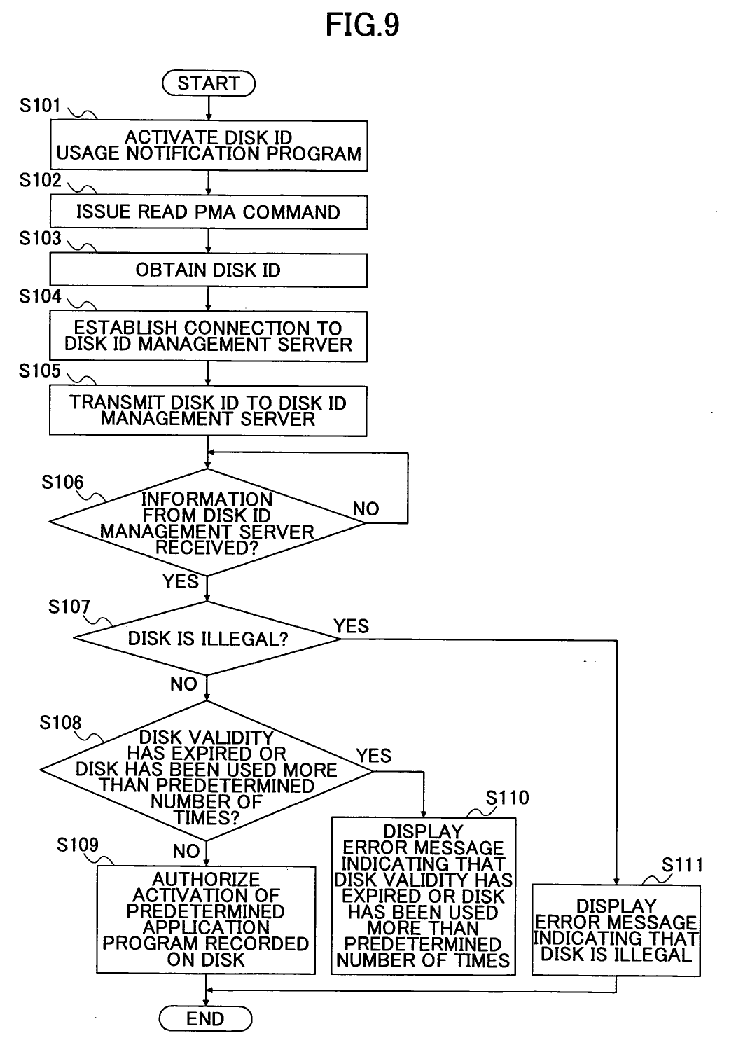

FIG. 9 is a flowchart showing the other operation of the client PC 2.

According to this operation, in step S101, the disk ID usage notification program is activated. Then, in step S102, the disk ID usage notification program issues a READ PMA command, and in step S103, obtains the disk ID of the hybrid disk 3. Then, in step S104, the disk ID usage notification program establishes a connection to the disk ID management server 1, and in step S105, transmits the disk ID to the disk ID management server 1.

In step S106, the disk ID usage notification program determines whether the information from the disk ID management server 1 is received. If the information from the disk ID management server 1 is received (that is, “YES” in step S106), in step S107, the disk ID usage notification program determines whether the information received from the disk ID management server 1 indicates that the hybrid disk 3 is illegal. If the information received from the disk ID management server 1 indicates that the hybrid disk 3 is illegal (that is, “YES” in step S107), in step S111, the disk ID usage notification program displays an error message indicating the use of an illegal disk, and ends the operation.

If the information received from the disk ID management server 1 does not indicate that the hybrid disk 3 is illegal (that is, “NO” in step S107), in step S108, the disk ID usage notification program determines whether or not the information received from the disk ID management server 1 indicates that the validity of the hybrid disk 3 has expired or that the hybrid disk 3 has been used more than a predetermined number of times. If the information received from the disk ID management server 1 indicates that the validity of the hybrid disk 3 has expired or that the hybrid disk 3 has been used more than the predetermined number of times (that is, “YES” in step S108), in step S110, the disk ID usage notification program displays an error message indicating that the validity of the hybrid disk 3 has expired or that the hybrid disk 3 has been used more than the predetermined number of times, and ends this operation. If the information received from the disk ID management server 1 indicates that neither the validity of the hybrid disk 3 has expired nor the hybrid disk 3 has been used more than the predetermined number of times (that is, “NO” in step S108), in step S109, the disk ID usage notification program authorizes the activation of a predetermined application program recorded on the hybrid disk 3, and ends this operation.

The above-described processing is based on the premise that a disk ID characteristic of the hybrid disk 3 is written thereto by a disk supplier in the process of manufacturing the hybrid disk 3. On the other hand, the above-described processing may also be performed based on the premise that no disk ID is written to the hybrid disk 3 in its manufacturing process.

A description is given below of this case.

A disk ID to be assigned to the hybrid disk 3 is prestored in the internal memory such as a ROM of the drive 4 for reading information from and writing information to the hybrid disk 3.

The disk ID to be assigned to the hybrid disk 3 is provided by the manufacturer of the hybrid disk 3 or the operator of the disk ID management server 1. As described above, the disk ID is linked to the disk ID management database 5 of the disk ID management server 1.

When the hybrid disk 3 is inserted into the drive 4, the drive 4 reads the PMA area of the hybrid disk 3. If the reading shows that no disk ID is written to the PMA area, the drive 4 writes the assignable disk ID stored in its internal memory (ROM area) to the hybrid disk 3.

Thereafter, an application for using the disk ID may be transmitted to the disk ID management server 1 as described above.

This case has the merit that the hybrid disk supplier may manufacture multiple hybrid disks of one type to which no disk ID is written.

A program for causing a computer to execute the above-described processing may be prestored in a ROM that is a computer-readable recording medium. If the program is stored in a computer-readable recording medium such as an optical disk, the functions according to this embodiment may be realized by installing the program in an optical disk unit from the optical disk. If the program is installed in a host computer connected to the optical disk unit, it is possible to cause the optical disk unit to realize the functions according to the present invention by controlling the optical disk unit from the host computer.

As described above, according to the method of reproducing information and the client/server system of the present invention, user convenience regarding data to be provided to a user can be provided and illegal use of the data can be prevented by unifying the management of the data. Further, according to the server, the client, and the program of the present invention, the functions for providing user convenience regarding data to be provided to a user and preventing illegal use of the data can be realized easily by unifying the management of the data in a normal computer. Furthermore, according to the computer-readable recording medium of the present invention, the functions according to the present invention can be realized by installing the program recorded on the recording medium.

The present invention is not limited to the specifically disclosed embodiment, and variations and modifications may be made without departing from the scope of the present invention.

The present application is based on Japanese priority patent application No. 2003-078124, filed on Mar. 20, 2003, the entire contents of which are hereby incorporated by reference.

What is claimed is:

1. A method of reproducing information using an information recording medium in a client/server system, the method comprising the steps of:
(a) a client obtaining characteristic information of the information recording medium;
(b) the client transmitting the characteristic information to a server;
(c) the server obtaining usage information of the information recording medium based on the characteristic information;
(d) the server transmitting information based on the usage information to the client; and
(e) the client reproducing the information recorded on the information recording medium in accordance with the information based on the usage information.

2. A method of reproducing information using an information recording medium in a client/server system, the method comprising the steps of:
(a) a client obtaining characteristic information of the information recording medium;
(b) the client transmitting the characteristic information to a first server;
(c) the first server obtaining usage information of the information recording medium based on the characteristic information;
(d) the first server transmitting first information based on the usage information to a second server;
(e) the second server transmitting second information stored therein to the client in accordance with the first information based on the usage information; and
(f) the client reproducing the information based on the second information received from the second server.

3. The method as claimed in claim 2, wherein in said step (b), the client transmits the characteristic information to the first server via the second server.

4. A client/server system reproducing information using an information recording medium, comprising:
a client; and
a server,
wherein the client includes:
a part configured to obtain characteristic information of the information recording medium;
a part configured to transmit the characteristic information to the server; and
a part configured to reproduce the information recorded on the information recording medium in accordance with information based on usage information of the information recording medium transmitted from the server; and
the server includes:
a part configured to obtain the usage information based on the characteristic information of the information recording medium; and
a part configured to transmit the information based on the usage information to the client.

5. A server providing information to a client using an information recording medium in response to a request of the client, the server comprising:
a first part configured to receive characteristic information of the information recording medium from the client;
a second part configured to obtain usage information of the information recording medium based on the characteristic information; and
a third part configured to transmit to the client information as to whether reproduction of information from the information recording medium is authorized based on the usage information.

6. The server as claimed in claim 5, further comprising:
a fourth part configured to receive from the client the characteristic information of the information recording medium and notification requesting stoppage of usage of the characteristic information; and
a fifth part configured to delete the usage information of the information recording medium based on the characteristic information.

7. A computer-readable recording medium storing a program for causing a computer to execute a method, the method comprising the steps of:
(a) receiving, based on a request of a client using an information recording medium, characteristic information of the information recording medium from the client;
(b) obtaining usage information of the information recording medium based on the characteristic information; and
(c) transmitting to the client information as to whether reproduction of information from the information recording medium is authorized based on the usage information.

8. The computer-readable recording medium as claimed in claim 7, wherein the method further comprises the steps of:
(d) receiving from the client the characteristic information of the information recording medium and notification requesting stoppage of usage of the characteristic information; and
(e) deleting the usage information of the information recording medium based on the characteristic information.

9. A client requesting a server to provide information thereto, the client using an information recording medium, the client comprising:
a first part configured to obtain characteristic information of the information recording medium;
a second part configured to transmit the characteristic information to the server so that the server obtains usage information of the information recording medium;
a third part configured to receive information based on the usage information from the server; and
a fourth part configured to reproduce information recorded on the information recording medium in accordance with the information based on the usage information.

10. A computer-readable recording medium storing a program for causing a computer to execute a method, the method comprising the steps of:
(a) obtaining characteristic information of an information recording medium;
(b) requesting a server to provide information and transmitting the characteristic information to the server so that the server obtains usage information of the information recording medium;
(c) receiving information based on the usage information from the server; and
(d) reproducing information recorded on the information recording medium in accordance with the information based on the usage information.
